(19) United States
(12) Patent Application Publication
(10) Pub. No.: US 2018/0229581 A1
(43) Pub. Date: Aug. 16, 2018

(54) Refrigerant Cooled Coaxial Fuel Rail

(71) Applicant: Fredrico Burke, Alhambra, CA (US)

(72) Inventor: Fredrico Burke, Alhambra, CA (US)

(21) Appl. No.: 15/950,860

(22) Filed: Apr. 11, 2018

Related U.S. Application Data
(63) Continuation-in-part of application No. 14/942,576, filed on Nov. 16, 2015, now Pat. No. 9,987,903.
Application No. 14/942,576 is a continuation-in-part of application No. 14/076,253, filed on Nov. 10, 2013, now Pat. No. 9,186,953.
Application No. 14/076,253 is a continuation-in-part of application No. 13/135,062, filed on Jun. 24, 2011, now Pat. No. 9,261,056.

(51) Int. Cl. B60H 1/00; F01P 3/20; F02M 31/20

(52) U.S. Cl. CPC B60H 1/00271; F02M 31/20; F01P 3/20

(57) ABSTRACT

An engine fuel cooling system for vehicles exchanges heat between fuel and a flow of cold liquid in a coaxial fuel rail. The coaxial fuel rails include an inner fuel path through an inner tube surrounded by an outer cold liquid path through an outer tube, to cool the fuel provided to fuel injectors. The inner tube has no substantial direct contact with the outer tube to prevent external heat from being conducted to the inner tube. In one embodiment, the inner tube is solely supported by an fuel inlet fitting and injector hats teaching through the outer tube and into the inner tube. The coaxial fuel rail may be constructed using dip soldering.

### CROSS-REFERENCE TO RELATED APPLICATIONS

The present application is a Continuation in Part of U.S. patent application Ser. No. 13/135,062, filed Jun. 24, 2011, and is a Continuation in Part of U.S. patent application Ser. No. 14/076,253 filed Nov. 10, 2013, and is a Continuation in Part of U.S. patent application Ser. No. 14/942,576 filed Nov. 16, 2015, which applications are incorporated in its entirety herein by reference.

### BACKGROUND OF THE INVENTION

The present invention relates to internal combustion engines and in particular to reducing the temperature of fuel and air provided to the engines to improve performance.

Many modern vehicles have small displacement supercharged or turbo charged engines to improve mileage, or moderate to large displacement supercharged or turbo charged engines to improve performance. An unavoidable consequence of supercharging or turbo charging is an increase in intake air temperature. The increased air temperature may cause detonation (e.g., pre-ignition or pinging) under acceleration when the fuel air mixture is ignited prematurely, and limits the amount of boost (increased air pressure) which may be used. Uncontrolled detonation may damage or destroy the engine.

Heat enchanters, commonly referred to as intercoolers, are often added to supercharged or turbo charged engines between the supercharger or turbo charger and the engine to at least somewhat cool the intake air. These intercoolers maybe air to air, or air to coolant. The air to coolant intercoolers require a second coolant to air heat exchanger in an ambient air stream to cool the coolant. Unfortunately, it is often difficult to obtain the desired amount of cooling with known intercoolers, thus limiting potential of the supercharger of turbo charger to increase performance.

Additionally, detonation may be reduced by cooling the liquid fuel provided to the engine, having a similar effect as cooling the intake air. Common methods for cooling liquid fuel include containers filled with ice and coiled fuel lines passing through the containers. Unfortunately, the fuel may be immediately heated upon leaving the container, and the ice melts quickly, making this approach only useful for a very brief period of time.

U.S. Pat. No. 6,269,804 discloses fuel rails having a coolant line running therethrough. Unfortunately, the fuel is exposed to the fuel rail housing, and presence of the coolant line provides very little reduction in fuel temperature.

### BRIEF SUMMARY OF THE INVENTION

The present invention addresses the above and other needs by providing an engine fuel cooling system for vehicles exchanges heat between fuel and a flow of cold liquid in a coaxial fuel rail. The coaxial fuel rails include an inner fuel path through an inner tube surrounded by an outer cold liquid path through an outer tube, to cool the fuel provided to fuel injectors. The inner tube has no substantial direct contact with the outer tube to prevent external heat from being conducted to the inner tube. In one embodiment, the inner tube is solely supported by an fuel inlet fitting and injector hats teaching through the outer tube and into the inner tube. The coaxial fuel rail may be constructed using dip soldering.

In accordance with one aspect of the invention, there is provided an engine fuel and air cooling system for vehicles which provides a refrigerant circuit producing a cold refrigerant flow. The cold refrigerant is passed through the coaxial fuel rails to cool fuel provided to an engine.

In accordance with another aspect of the invention, there is provided an engine fuel and air cooling system for vehicles which exchanges heat between a coolant and air conditioning system refrigerant. The system provides a refrigerant circuit producing a cold refrigerant flow and a coolant circuit producing a cold coolant flow. The coolant is cooled in a heat exchanger by the cold refrigerant flow. The cold coolant is passed through the coaxial fuel rails to cool fuel provided to an engine.

In accordance with yet another aspect of the invention, there is provided an engine fuel and air cooling system, including a coaxial fuel rail containing an inn tube distributing fuel to injector hats, and an outer tube containing a flow of cold liquid produced by an air conditioning system. The inner tube is substantially thermally isolated from the outer tube to prevent heat from being conducted to the inner tube.

In accordance with still another aspect of the invention, there is provided an engine fuel cooling system including a coaxial fuel rail constructed using dip soldering. An inner tube containing fuel is solely connected to the outer tube by a fuel inlet fitting and injector hats passing through the outer tube and into the inner tube.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a general diagram of a fuel and air cooling system according to the present invention, for use with an internal combustion engine.

FIG. 2 is a diagram of the fuel and air cooling system according to the present invention, with refrigerant cool features turned off.

FIG. 3 shows a typical physical layout of the fuel and air cooling system according to the present invention, with refrigerant cool features turned off.

FIG. 4 is a diagram of the fuel and air cooling system according to the present invention, with refrigerant cooling provided to cabin interior only.

FIG. 5 is a diagram of the fuel and air cooling system according to the present invention, with refrigerant cooling provided to cabin interior and partially to the fuel and air.

FIG. 6 is a diagram of the fuel and air cooling system according to the present invention, with refrigerant cooling provided to the fuel and air only.

FIG. 7 shows a refrigerant manifold according to the present invention.

FIG. 8 is an exploded view of a coaxial fuel and coolant rail according to the present invention.

FIG. 9 shows fuel cooling blocks clamped over fuel lines entering fuel injector hats according to the present invention.

FIG. 10 shows a cross-sectional view of the fuel cooling blocks according to the present invention.

FIG. 11 shows a second coaxial flow fuel and coolant rail according to the present invention.

FIG. 12 shows a cross-sectional view of the second coaxial flow fuel and coolant rail according to the present invention taken along line 12-12 of FIG. 11.

FIG. 13 shows a second cross-sectional view of the second coaxial flow fuel and coolant rail according to the present invention taken along line 13-13 of FIG. 11.

FIG. 14 shows a third cross-sectional view of the second coaxial flow fuel and coolant rail according to the present invention taken along line 14-14 of FIG. 11.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

The term “fuel” is used herein to refer to liquid fuel (gasoline, diesel, alcohol and the like) mixed with air for combustion in internal combustion engines.

The term “supercharger” is used hereafter to refer to any type of forced induction device including belt driven superchargers and turbo superchargers.

The term “refrigerant” is used herein to refer to common refrigerants used in mobile air conditioning systems. Preferred refrigerants have a vaporization temperature at or below −61 degrees Fahrenheit at ambient pressure.

The term “coolant” is used herein to refer to common liquid coolant used to cool internal combustion engines. These include, water, glycol, a water and rust inhibitor mix, a water glycol mix, and the like. Coolants have a vaporization temperature above 212 degrees Fahrenheit at ambient pressure.

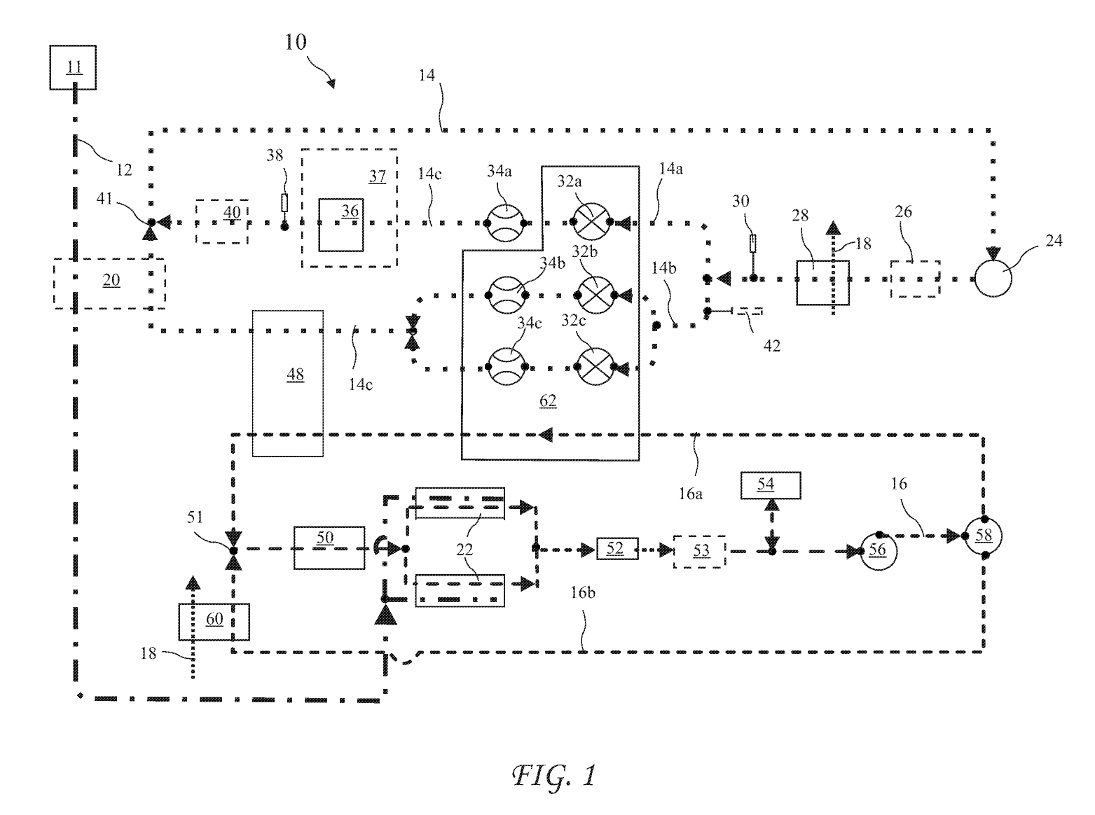

A general diagram of a fuel and air cooling system 10 according to the present invention, for use with an internal combustion engine, is shown in FIG. 1. The fuel and air cooling system 10 includes a flow of fuel 12 from a fuel tank 11, a flow of refrigerant 14, a flow of coolant 16, and flows of ambient air 18. The refrigerant 14 starts at a compressor 24 which compresses the refrigerant. The compressed coolant 14 passed through an optional accessory heater 26. The optional accessory heater 26 may provide heat for auxiliary functions, such as beverage heating, glove heating, etc. The compressed refrigerant 14 then passes through a condenser 28. The condenser 28 also receives a flow of ambient air 18 and acts as a heat exchanger to cool the refrigerant 14. A high pressure cutout 30 follows the condenser 28 and stops the compressor 24 whenever the refrigerant pressure becomes excessive. The refrigerant 14 then splits between a flow of cabin refrigerant 14a and a flow of fuel and air refrigerant 14b.

The flow of cabin refrigerant 14a passes through a cabin air conditioning system including a cabin circuit valve 32a and then a cabin circuit expansion valve 34a producing cold refrigerant 14c. A cabin heat exchanger (also called an evaporator coil) 36 residing in or proximal to a vehicle cabin 37, a cabin thermostat 38, and optionally, a heat exchanger 40 for cooling fuel, oil, coolant, beverages, and the like.

The flow of fuel and air refrigerant 14b is separated into two parallel flows to pass through a fuel system including a primary fuel and air circuit valve 32b and then a primary fuel and air circuit expansion valve 34b, and secondary fuel and air circuit valve 32c and then a secondary fuel and air circuit expansion valve 34c producing parallel flows of cold refrigerant 14c, and then recombine the parallel flows of cold refrigerant 14c. The recombined flow of fuel and air refrigerant 14c passed through a heat exchanger 48, optionally through a fuel pre-cooler 20, and re-joins the flow of cabin refrigerant 14c at refrigerant node 41 to return to the compressor 24.

The coolant 16 is circulated by a pump 56. The coolant 16 splits into a flow of refrigerated coolant 16a and a flow of air cooled coolant 16b. The refrigerated coolant 16a passes through the heat exchanger 48 where it is cooled by the fuel and air refrigerant 14b. The air cooled coolant 16b passed through a heat exchanger (radiator) 60 where it is cooled by the flow of ambient air 18. After being cooled, the refrigerated coolant 16a and air cooled coolant 16b join at coolant node 51, and flow sequentially through an intake air intercooler 50 and fuel rails 22. Supercharging heats the air compressed in the supercharger and the intercooler 50 is preferably, but not necessarily, a supercharger intercooler and cools air compressed by a supercharger before entry into an engine. The flow of coolant through the fuel rails 22 cools the fuel 12 before injection into the engine. The coolant flow 16 then proceeds through a sight glass and filter 52, optionally through an intake air pre-cooler 53, past an expansion/reservoir tank 54, and back to the coolant pump 56.

A refrigerant manifold 62 preferably houses the solenoid valves 32a, 32b, and 32c, and the expansion valves 34b and 34c. The cabin circuit expansion valve 34a is preferably the original equipment expansion valve of the vehicle the fuel and air cooling system 10 is installed in. The refrigerated coolant 16a preferably passes through the refrigerant manifold 62 to cool the refrigerant manifold 62. Details of the refrigerant manifold 62 are shown in FIG. 7. The primary expansion valve 34b is sized to operate with the cabin air conditioning on and is generally between 0.25 and one tons (or 3,000 to 12,000 BTUs). The secondary expansion valve 34c is sized between 1.5 and 2 ton (or 18,000 to 24,000 BTUs) to operate with the primary expansion valve when the cabin air conditioning of off.

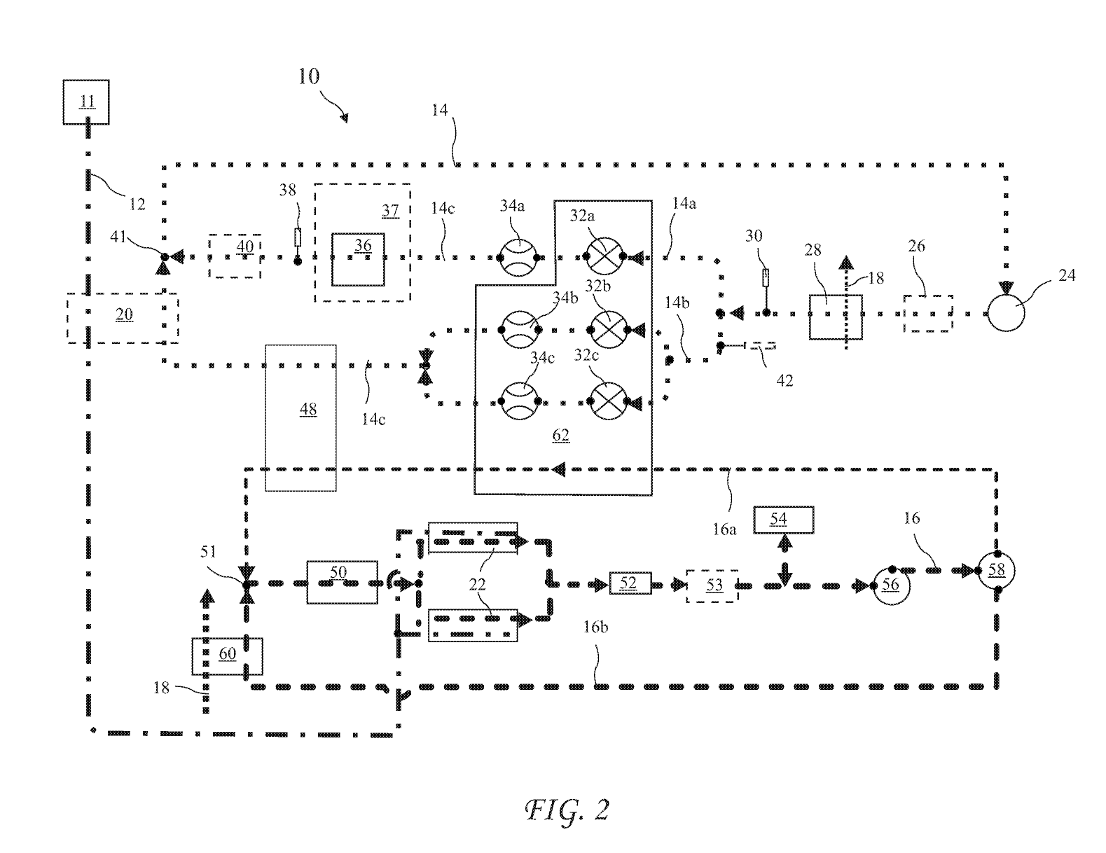

A diagram of a fuel and air cooling system 10 with refrigerant cooling features (e. g., the compressor 24) turned off is shown in FIG. 2. The only active fuel and air cooling path is the air cooled coolant 16b through the heat exchanger 60 shown as heavier lines. The air cooled coolant 16b passed through the heat exchanger 60 where it is cooled by the flow of ambient air 18. After being cooled, the air cooled coolant 16b flows sequentially through the supercharger intercooler 50 and fuel rails 22. The intercooler 50 cools the air compressed by the supercharger before entry into the engine. The flow of the air cooled coolant 16b through the fuel rails 22 cools the fuel 12 before injection into the engine. The coolant flow 16 then proceeds through the sight glass and filter 52, optionally through the intake air pre-cooler 53, past an expansion/reservoir tank 54, and back to the coolant pump 56.

In other embodiments the cold refrigerant 14c may be directly supples to the intercooler 50 and/or the fuel rails 22, and when the cold refrigerant 14c is directly supplied to both the intercooler 50 and the fuel rails 22, the order of the intercooler 50 and the fuel rails 22 may be the intercooler 50 first, or the fuel rails 22 first.

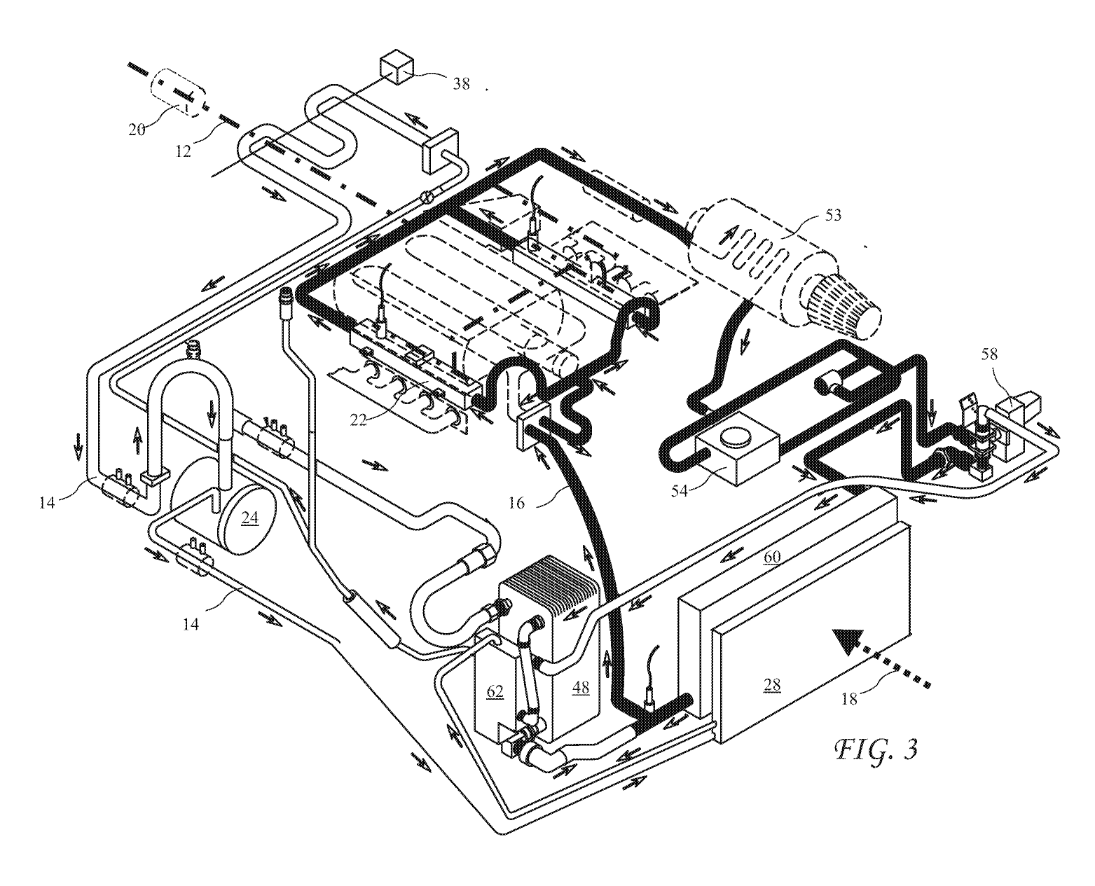

An example of a physical layout of the fuel and air cooling system 10, in the fuel and air cooling mode of FIG. 2, is shown in FIG. 3.

A diagram of a fuel and air cooling system 10 with refrigerant cooling only provided for the cabin 37 is shown in FIG. 4. The only active fuel and air cooling path is the air cooled coolant 16b through the heat exchanger 60 shown as heavier lines. The cabin circuit solenoid valve 34a is open allowing the cabin refrigerant 14a to flow freely, and the primary and secondary fuel and air circuit solenoid valves 34b and 34c are closed. The cabin refrigerant 14a flows through the cabin circuit expansion valve, the cabin heat exchanger 36, and back to the compressor 24.

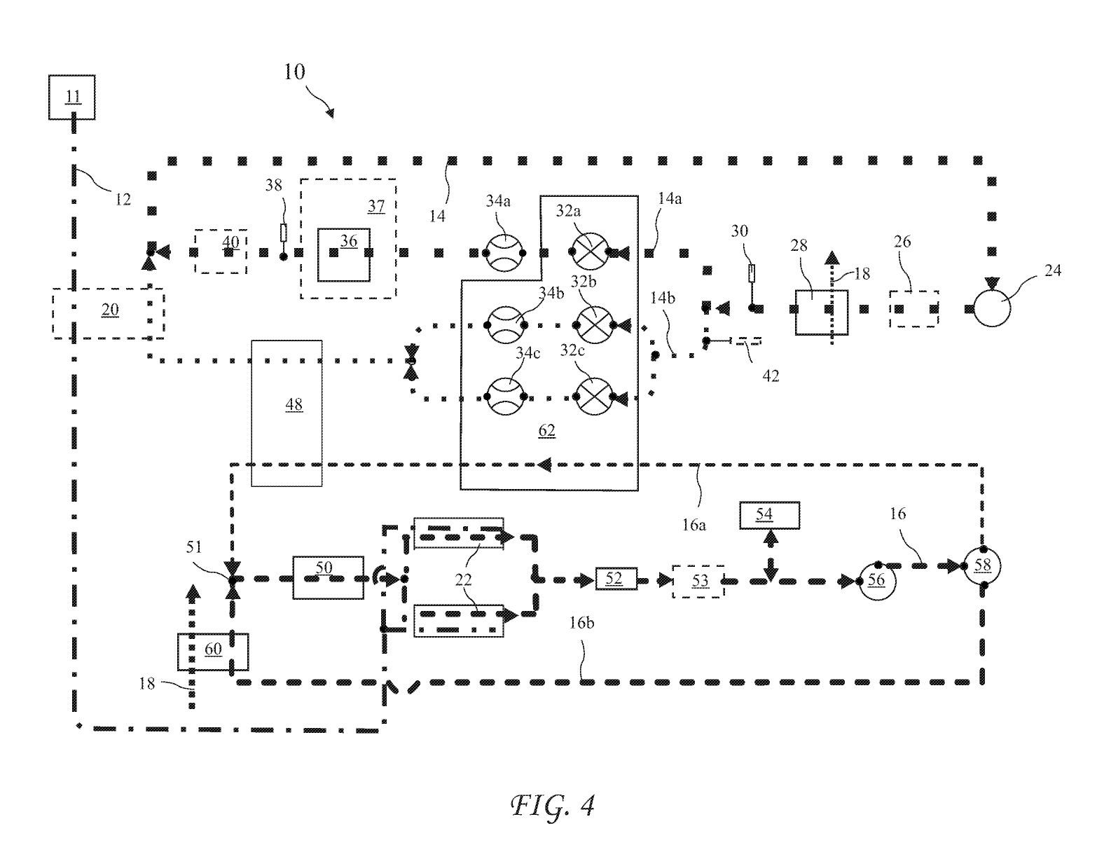

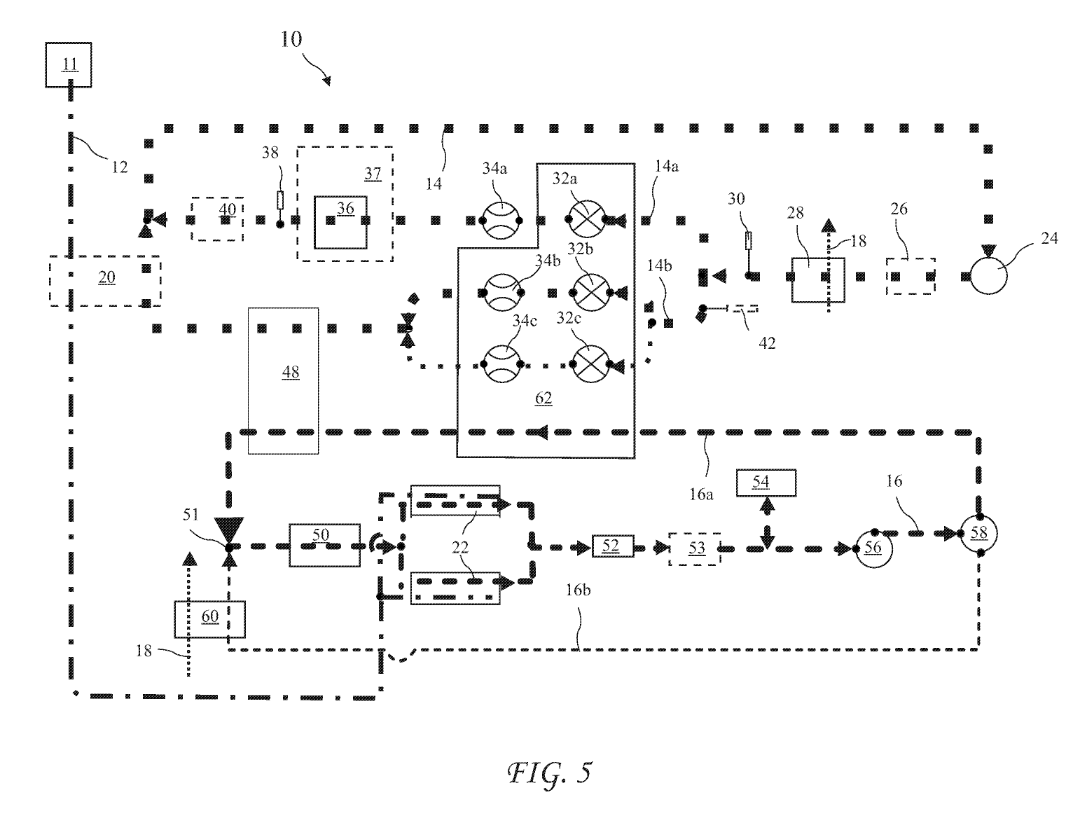

A diagram of the fuel and air cooling system 10, with refrigerant cooling provided to cabin interior and the fuel and air is shown in FIG. 5. The cabin circuit solenoid valve 34a is open allowing the cabin refrigerant 14a to flow freely, and the primary fuel and air circuit solenoid valve 34b is open allowing a partial flow of fuel and air refrigerant. The secondary fuel and air circuit solenoid valve 34c is closed. The cabin refrigerant 14a flows through the cabin circuit expansion valve, the cabin heat exchanger 36, and back to the compressor 24. The fuel and air refrigerant 14b flows through the primary fuel and air circuit expansion valve 34b and through the refrigerant to coolant heat exchanger 48, and then joins the cabin refrigerant 14a and returns to the compressor 24.

The coolant pump 56b pumps the coolant 16 to the two way valve 58 which is set to allow the refrigerated coolant 16a to pass through the coolant heat exchanger 48 to be cooled by the fuel and air refrigerant 14b. After being cooled, the refrigerated coolant 16a flows sequentially through the supercharger intercooler 50 and fuel rails 22. In the intercooler 50, the refrigerated coolant 16a cools the air compressed by the supercharger before entry into the engine. The refrigerated coolant 16a flows through the fuel rails 22 to cool the fuel 12 before injection into the engine. The coolant flow 16 then proceeds through the sight glass and filter 52, optionally through the intake air pre-cooler 53, past an expansion/reservoir tank 54, and back to the coolant pump 56.

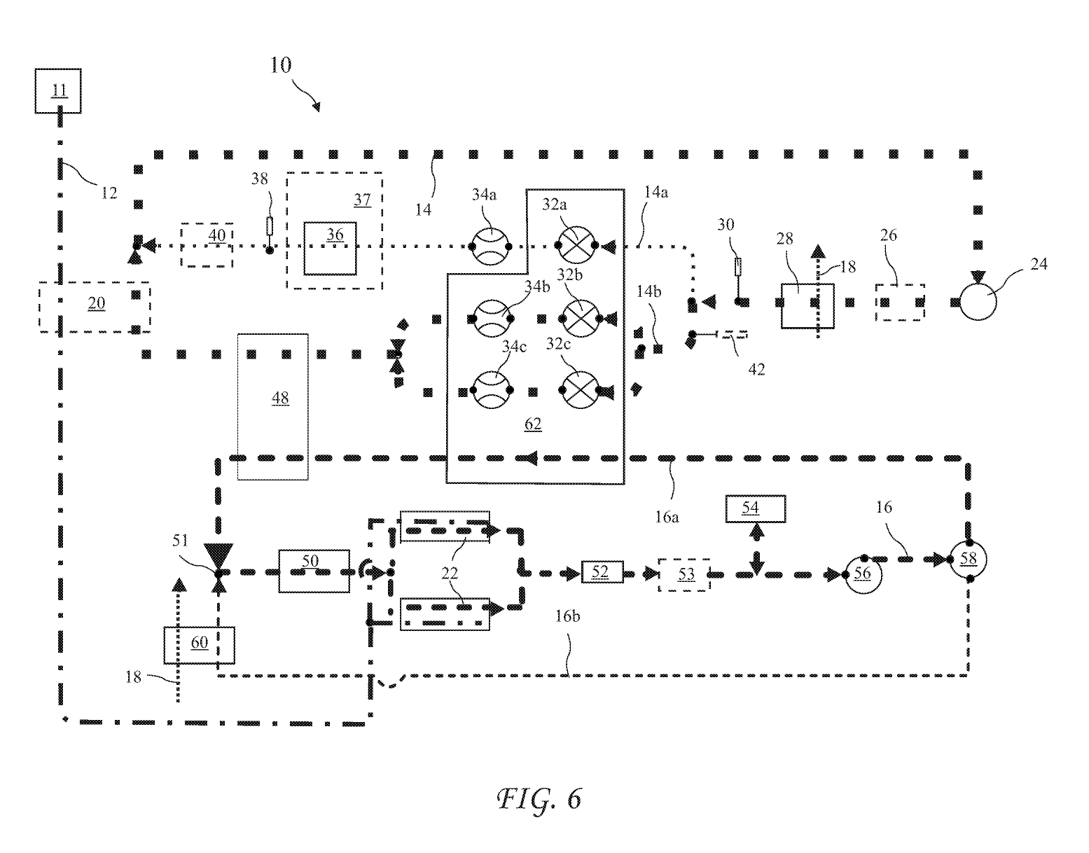

A diagram of the fuel and air cooling system 10 with refrigerant cooling provided to the fuel and air only is shown in FIG. 6. The cabin circuit solenoid valve 34a is closed preventing the cabin refrigerant 14a from flowing, and the primary and secondary fuel and air circuit solenoid valves 34b and 34c are open allowing a maximum flow of fuel and air refrigerant. The fuel and air refrigerant 14b flows through the primary and secondary fuel and air circuit expansion valves 34b and 43c, and through the refrigerant to coolant heat exchanger 48, and then returns to the compressor 24.

The coolant pump 56b pumps the coolant 16 to the two way valve 58 which is set to allow the refrigerated coolant 16a to pass through the coolant heat exchanger 48 to be cooled by the fuel and air refrigerant 14b. After being cooled, the refrigerated coolant 16a flows sequentially through the supercharger intercooler 50 and fuel rails 22. In the intercooler 50, the refrigerated coolant 16a cools the air compressed by the supercharger before entry into the engine. The refrigerated coolant 16a flows through the fuel rails 22 to cool the fuel 12 before injection into the engine. The coolant flow 16 then proceeds through the sight glass and filter 52, optionally through the intake air pre-cooler 53, past an expansion/reservoir tank 54, and back to the coolant pump 56.

The refrigerant manifold 62 is shown in FIG. 7. The three solenoid valves 32a, 32b, and 32c are located in ports 32a′, 32b′ and 32c′ respectively. The refrigerant 14 enters the refrigerant manifold 62 and connects to the ports 32a′, 32b′, and 32c′. The valve 32a controls the cabin refrigerant 14a flowing from the refrigerant manifold 62 to the cabin expansion valve 43a residing outside the refrigerant manifold 62. The solenoid valves 32b and 32c control flows of the fuel and air refrigerant to the fuel and air expansion valves 34b and 34c respectively. Flow from the fuel and air expansion valves 34b and 34c combine and exit the refrigerant manifold 62 to the refrigerant to coolant heat exchanger 48 (see FIG. 1). The refrigerated coolant 16a flows through the refrigerant manifold 62 to cool the refrigerant manifold 62.

An exploded view of a coaxial fuel and coolant rail 80 is shown in FIG. 8. The rail 80 includes an outer coolant tube 72 and an inner fuel rail 74. The outer coolant tube 72 is shown separated in halves for the purpose of illustration only, and the coaxial fuel and coolant rail 80 may be constructed in other manners. A fuel inlet 76 passes through the outer coolant tube 72 and into the fuel rail 74. Injector hats 78 extend down from the fuel rail 74 and seal to fuel injectors. Coolant inlet 80a and outlet 80b reside at opposite ends of the outer coolant tube 72. At least one temperature sensor 82 extends through the outer coolant tube 72 and into the fuel rail 74 to measure fuel temperature, and a pressure sensor fitting 76 extends through the outer coolant tube 72 and into the fuel rail 74 to measure fuel pressure.

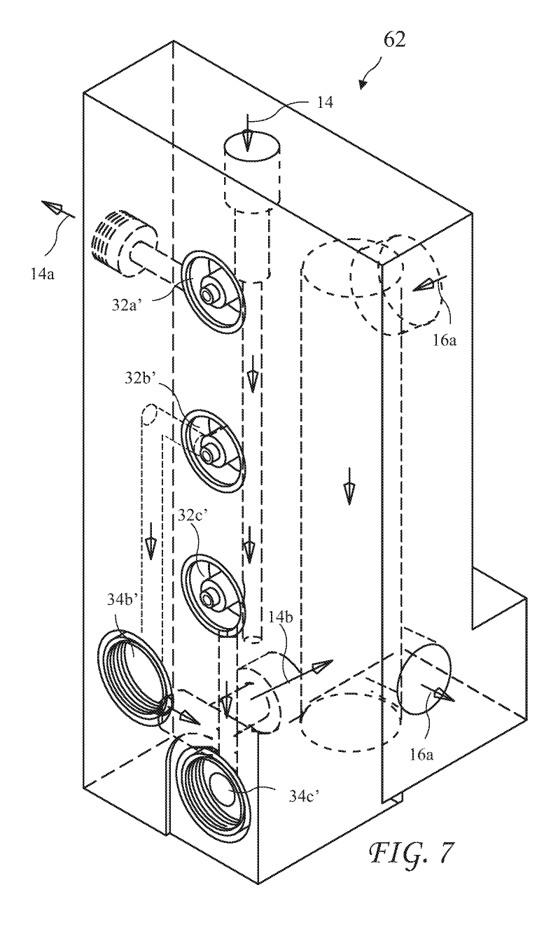

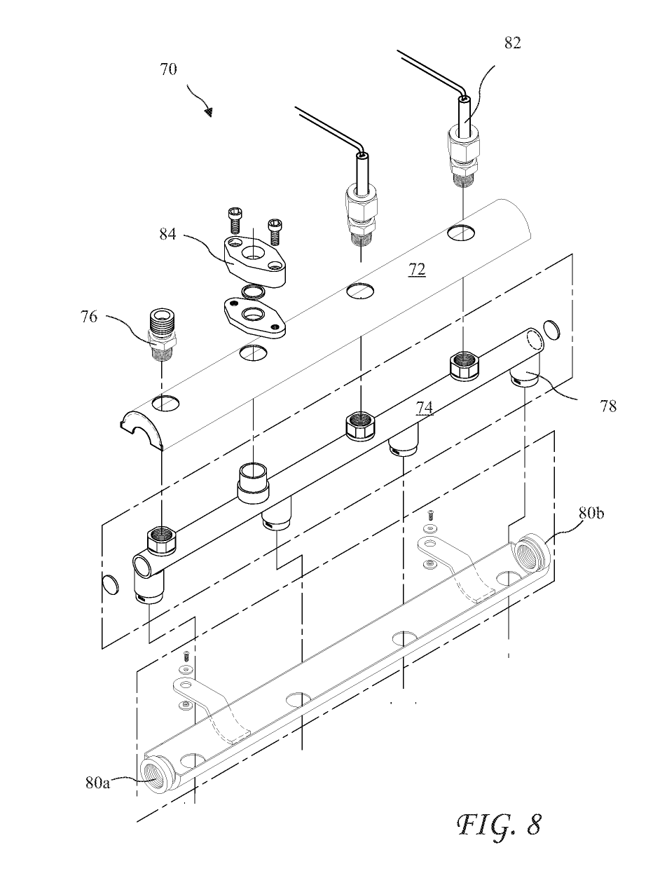

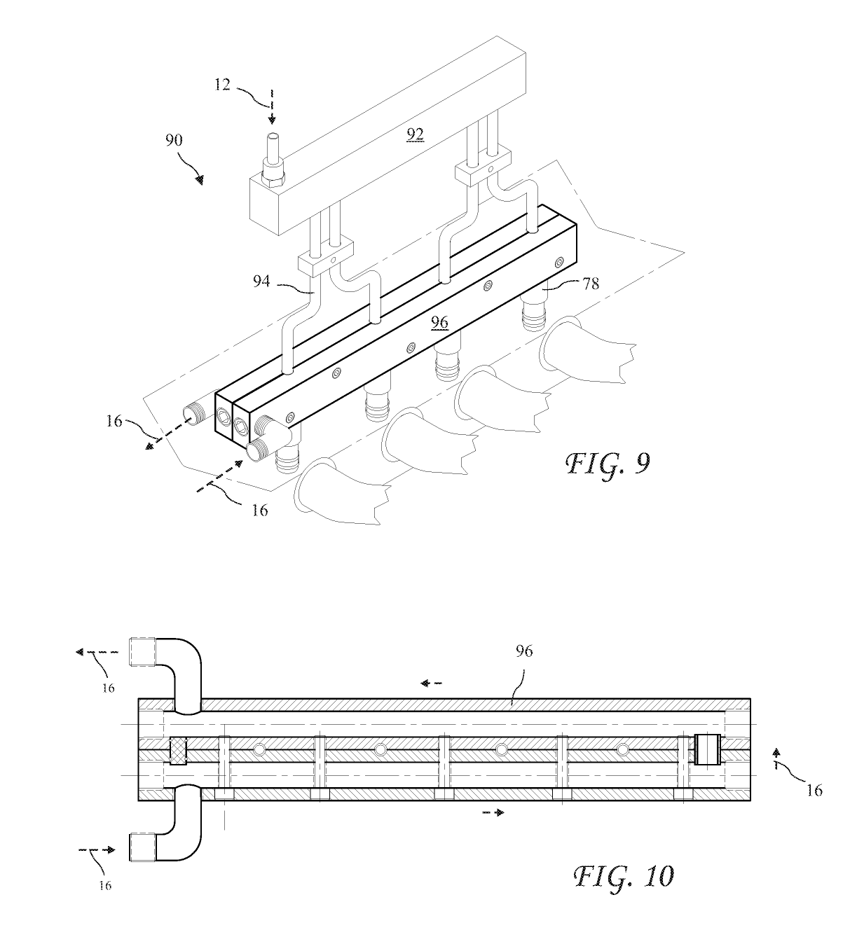

Fuel cooling blocks 96 clamped over fuel lines 94 and fuel injector hats 78 are shown in FIG. 9 and a cross-sectional view of the fuel cooling blocks 96 is shown in FIG. 10. The flow of coolant 16 passes through one side of the fuel cooling blocks 96 and then back through an opposite side. The fuel lines 94 reach from a fuel manifold 92 and into the fuel cooling blocks 96, and the into the fuel injector hats 78, thus cooling the fuel 12 just before injection of the fuel 12 into the engine.

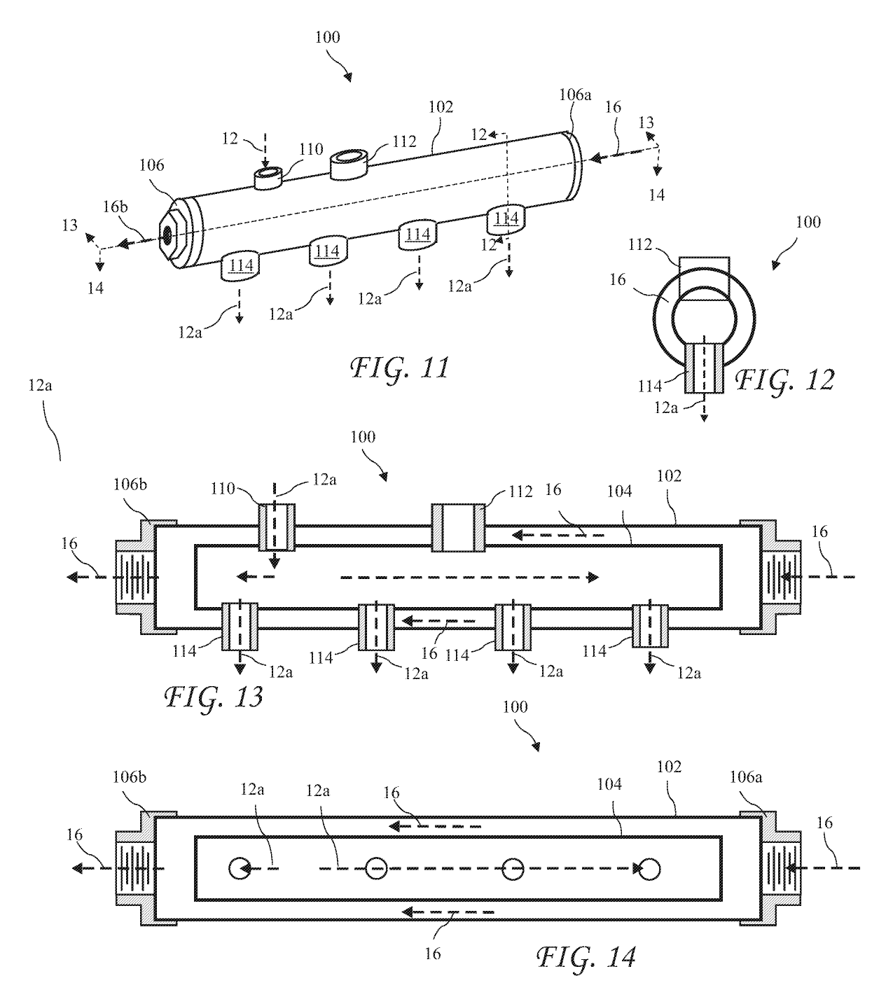

A second coaxial flow fuel and coolant rail 100 is shown in FIG. 11, a cross-sectional view of the coaxial flow fuel and coolant rail 100 taken along line 12-12 of FIG. 11 is shown in FIG. 12, a second cross-sectional view of the coaxial flow fuel and coolant rail 100 taken along line 13-13 of FIG. 11 is shown in FIG. 13, and a third cross-sectional view of the coaxial flow fuel and coolant rail 100 taken along line 14-14 of FIG. 11 is shown in FIG. 14. The coaxial flow fuel and coolant rail 100 has a outer tube 102 and an inner tube 104. The fuel flow 12 enters the inner tube 104 through inlet 110 and leaves the inner tube 104 through injector hats 114 as a cooled fuel flow 12a. The coolant 16 enters the outer tube 102 through coolant fitting 106a and leaves the outer tube 102 through coolant fitting 106. The inner tube 104 is preferably solely held in position by the inlet fitting 110 and the injector hats 114 and may be constructed by dip soldering the inlet fitting 110 and the injector hats 114 to the tubes 102 and 104. As a result, the inner tube 104 is substantially thermally isolated from the outer tube, that is, the only heat transfer between the outer tube to the inner tube is through the inlet fitting 110 and the injector hats 114. A sensor bung 112 reaches through the outer tube 102 into the inner tube to measure fuel pressure and/or temperature.

While the invention herein disclosed has been described by means of specific embodiments and applications thereof, numerous modifications and variations could be made thereto by those skilled in the art without departing from the scope of the invention set forth in the claims.

I claim:

1. A fuel cooling system for a vehicle including an internal combustion engine and an air conditioning system, said fuel cooling system comprising:
a coaxial fuel rail including an outer tube and an inner tube inside the outer tube and spaced apart from the outer tube;
a fuel inlet fitting passing through the outer tube and into the inner tube providing fluid communication between a fuel source and the inner tube;
injector hats passing from the inner tube and through the outer tube providing fluid communication between the inner tube and fuel injectors; and
the coaxial fuel rail in thermal communication with the air conditioning system, the coaxial fuel rail configured to receive a cold liquid flow produced by an air conditioning system into a space between the inner tube and the outer tube, and a fuel flow from the fuel source through the fuel inlet fitting and into the inner tube, wherein heat is conducted from the fuel flow through walls of the inner tube into the cold liquid flow.

2. The fuel cooling system of claim 1, wherein the inner tube has no direct contact with the outer tube.

3. The fuel cooling system of claim 2, wherein the inner tube is held in position inside the outer tube by the fuel inlet fitting and the injector hats.

4. The fuel cooling system of claim 3, wherein the fuel inlet fitting and the injector hats are attached to the inner tube and the outer tube by dip soldering.

5. The fuel cooling system of claim 3, further including a sensor bung passing through the outer tube and into the inner tube, wherein the inner tube is solely held in position inside the outer tube by the fuel inlet fitting, the sensor bung, and the injector hats.

6. The fuel cooling system of claim 1, wherein the cold liquid flow passes through both the coaxial fuel rail and an intake air heat exchanger.

7. The fuel cooling system of claim 6, wherein the cold liquid flow passes first through the coaxial fuel rail, and then through the intake air heat exchanger, before returning to the compressor.

8. The fuel cooling system of claim 6, wherein the cold liquid flow passes first through the intake air heat exchanger and then through the coaxial fuel, and refrigerant rail, before returning to the compressor.

9. The fuel cooling system of claim 7, wherein the cold liquid flow is a refrigerant flow from an expansion valve the air conditioning system and flowing from the coaxial fuel rail to a compressor of the air conditioning system.

10. The fuel cooling system of claim 7, wherein:
the cold liquid flow is a cold coolant flow;
the cold coolant flow is cooled in a heat exchanger by a cold refrigerant flow; and
the heat exchanger receives the cold refrigerant flow from an expansion valve of the air conditioning system and returns the cold refrigerant flow to a compressor of the air conditioning system

11. A fuel cooling system for a vehicle including an internal combustion engine and an air conditioning system, said fuel cooling system comprising:
a coaxial fuel rail including an outer tube and an inner tube inside the outer tube and spaced apart from the outer tube having no direct contact with the outer tube;
a fuel inlet fitting passing through the outer tube and into the inner tube providing fluid communication between a fuel source and the inner tube;
injector hats passing from the inner tube and through the outer tube providing fluid communication between the inner tube and fuel injectors;
a sensor bung passing from the inner tube and through the outer tube, wherein:
the inner tube is held in position inside the outer tube by the fuel inlet fitting, the sensor bung, and the injector hats; and
the fuel rails are constructed by dip soldering the outer tube, inner tube, fuel inlet fitting, the sensor bung, and the injector hats; and
the coaxial fuel rail configured to receive a cold refrigerant flow produced by an air conditioning system expansion valve into a space between the inner tube and the outer tube and a fuel flow from the fuel source through the fuel inlet fitting and into the inner tube, wherein heat is conducted from the fuel flow through walls of the inner tube into the cold refrigerant flow.

12. A fuel cooling system for a vehicle including an internal combustion engine and an air conditioning system, said fuel cooling system comprising:
a coaxial fuel rail including an outer tube and an inner tube inside the outer tube and spaced apart from the outer tube having no direct contact with the outer tube;
a fuel inlet fitting passing through the outer tube and into the inner tube providing fluid communication between a fuel source and the inner tube;
injector hats passing from the inner tube and through the outer tube providing fluid communication between the inner tube and fuel injectors;
a sensor bung passing from the inner tube and through the outer tube, wherein:
the inner tube is held in position inside the outer tube by the fuel inlet fitting, the sensor bung, and the injector hats; and
the fuel rails are constructed by dip soldering the outer tube, inner tube, fuel inlet fitting, the sensor bung, and the injector hats; and
the coaxial fuel rail is configured to receive a cold coolant flow through a space between the inner tube and the outer tube and a fuel flow from the fuel source through the fuel inlet fitting and into the inner tube, wherein heat is conducted from the fuel flow through walls of the inner tube into the cold coolant flow, the cold coolant flow cooled in a heat exchanger by a cold refrigerant flow produced by an air conditioning system expansion valve of the air conditioning system.
